(19) United States
(12) Patent Application Publication
(10) Pub. No.: US 2026/0140781 A1
(43) Pub. Date: May 21, 2026

(54) RESOURCE USAGE PREDICTION MODEL-BASED ORCHESTRATION METHOD IN SDI IMPLEMENTATION ENVIRONMENT

(71) Applicant: Korea Electronics Technology Institute, Seongnam-si (KR)

(72) Inventors: Jae Hoon AN, Incheon (KR); Young Hwan KIM, Yongin-si (KR); Han Gyeol KIM, Seongnam-si (KR)

(73) Assignee: Korea Electronics Technology Institute, Seongnam-si (KR)

(21) Appl. No.: 19/385,504

(22) Filed: Nov. 11, 2025

(30) Foreign Application Priority Data
Nov. 15, 2024 (KR) 10-2024-0162578

(51) Int. Cl. G06F 9/50; G06F 9/48

(52) U.S. Cl. CPC G06F 9/5038; G06F 9/4881; G06F 2209/5019; G06F 2209/505; G06F 2209/509

(57) ABSTRACT

Provided is a resource usage prediction model-based orchestration method in an SDI implementation environment. The orchestration method according to an embodiment may dynamically allocate resources to tasks according to importance, based on prediction of future resource usage through real-time monitoring of resource usage of an SD-mobility device such as an SDV, an SRD, an SDA in an SDI implementation environment, and may predict the occurrence of resource overload of the SD-mobility device and offload the tasks in association with a cloud system. Accordingly, limited resources of the SD-mobility device may be efficiently used and the SD-mobility device may be supported to maintain optimal performance.

### CROSS-REFERENCE TO RELATED APPLICATION(S) AND CLAIM OF PRIORITY

This application is based on and claims priority under 35 U.S.C. § 119 to Korean Patent Application No. 10-2024-0162578, filed on Nov. 15, 2024, in the Korean Intellectual Property Office, the disclosure of which is herein incorporated by reference in its entirety.

### BACKGROUND

### Field

The disclosure relates to software-defined infrastructure (SDI) implementation, and more particularly, to an orchestration method for maximizing performance and minimizing resource waste by efficiently distributing and managing resources given in an SDI environment.

### Description of Related Art

Software-defined technologies starting from software-defined networks (SDN) have gradually spread to software-defined storages (SDS), software-defined data centers (SDDC), software-defined infrastructures (SDI), and eventually are embraced in software-defined anything/everything (SDx).

Recently, research and development of SDI deployment technologies for software-defined (SD)-mobility devices, such as software-defined vehicles (SDV), software-defined robots (SDR), software-defined airspace (SDA), is actively underway.

The demerit of SD-mobility devices may be limited available resources. Accordingly, efficient use of resources and performance maximization of SD-mobility devices in an SDI implementation environment should be sufficiently considered in the above research and development.

### SUMMARY

The disclosure has been developed in order to solve the above-described

problems, and an object of the disclosure is to provide an orchestration method which allocates resources based on resource usage prediction of SD-mobility devices such as SDV, SDR, SDA in an SDI implementation environment, and offloads tasks into a cloud system based on resource overload prediction.

According to an embodiment of the disclosure to achieve the above-described object, an orchestration method may include: collecting, by a software-defined (SD)-mobility device, data in real time; analyzing, by the SD-mobility device, current workloads based on the collected data; predicting, by the SD-mobility device, necessary future resource usage for each task based on accumulated analysis results; and preferentially allocating, by the SD-mobility device, predicted necessary resources to an important task.

According to an embodiment, the orchestration method may further include holding, by the SD-mobile device, a general task or allocating minimum resources to the general task.

The important task may include a task related to traveling of the SD-mobility device, and a task that needs to be performed urgently among tasks for performing missions, and the general task may be a task except for the important task among the tasks of the SD-mobility device.

Collecting may include collecting sensor data in the process of traveling and performing a given mission, and the sensor may include at least one of a camera, a LiDAR, and a RADAR.

According to an embodiment of the disclosure, the orchestration method may further include: predicting, by the SD-mobility device, the occurrence of future resource overload by monitoring a resource use state; and, when the occurrence of future resource overload is predicted, offloading, by the SD-mobility device, some of the tasks into a cloud system.

According to an embodiment of the disclosure, the orchestration method may further include performing, by the cloud system, the offloaded task by dynamically adjusting its own resources based on the predicted necessary future resource usage.

Offloading may include offloading a traveling-related task among the tasks performed by the SD-mobility device, and an urgent task among the tasks for performing missions only in a special circumstance.

According to an embodiment of the disclosure, the orchestration method may further include scheduling, by a master cluster of the cloud system, the offloaded task for an optimal edge cluster, scheduling may be performed by weighted-summing a mixed importance and a predicted execution time, and the mixed importance may be calculated by weighted-summing regionality, efficiency, latency time, resource availability.

The SD-mobility device may be any one of a software-defined vehicle (SDV), a software-defined robot (SDR), and a software-defined airspace (SDA) which perform a given mission while traveling based on SD technologies.

According to another aspect of the disclosure, there is provided a software-defined mobility infrastructure (SDMI) system including: an SD-mobility device configured to collect data in real time, to analyze current workloads, to predict necessary future resource usage for each task based on accumulated analysis results, and preferentially allocate predicted necessary resources to an important task; and a cloud system connected with the SD-mobility device via a network.

According to still another aspect of the disclosure, there is provided an orchestration method including: predicting, by a SD-mobility device, the occurrence of future resource overload by monitoring a resource use state; and, when the occurrence of future resource overload is predicted, offloading, by the SD-mobility device, some of the tasks into a cloud system.

As described above, according to embodiments of the disclosure, resources may be dynamically allocated to tasks according to importance, based on prediction of future resource usage through real-time monitoring of resource usage of an SD-mobility device such as an SDV, an SRD, an SDA in the SDI implementation environment, so that limited resources may be efficiently used.

Furthermore, the SD-mobility device may be supported to maintain optimal performance by predicting the occurrence of resource overload in the SDI implementation environment and offloading tasks in association with the cloud system.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a software-defined mobility infrastructure (SDMI) system according to an embodiment of the disclosure;

FIG. 2 is a view illustrating an orchestration method in an SDI implementation environment according to another embodiment of the disclosure;

FIG. 3 is a view illustrating the orchestration method in the SDI implementation environment according to another embodiment of the disclosure; and

FIGS. 4A and 4B are views provided to additionally explain FIGS. 2 and 3.

### DETAILED DESCRIPTION

Hereinafter, the disclosure will be described in more detail with reference to the accompanying drawings.

Embodiments of the disclosure present an orchestration method in a software-defined infrastructure (SDI) implementation environment. The disclosure relates to a technique for dynamically allocating resources to tasks according to importance based on prediction of future resource usage of a software-defined (SD)-mobility device in an SDI implementation environment, and offloading tasks into a cloud system based on prediction of resource overload.

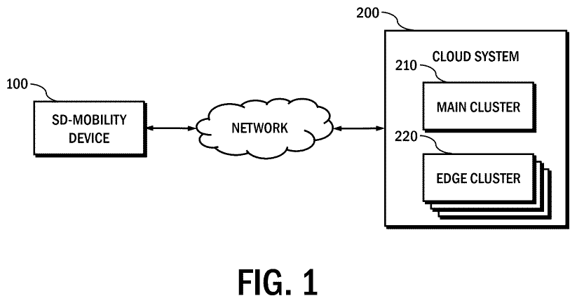

FIG. 1 is a view illustrating a software-defined mobility infrastructure (SDMI) system according to an embodiment of the disclosure. The SDMI system according to an embodiment may be established by connecting an SD-mobility device 100 and a cloud system 200 via a network.

The SD-mobility device 100 is a device that performs a given mission while traveling based on SD technologies, such as a software-defined vehicle (SDV), a software-defined robot (SDR), a software-defined airspace (SDA).

According to an embodiment, the SD-mobility device 100 may predict a future resource usage based on artificial intelligence (AI), and dynamically allocate limited resources based on task importance according to priority. In addition, the SD-mobility device 100 may predict resource overload based on AI, and may offload tasks into the cloud system 200.

The cloud system 200 may process tasks offloaded from the SD-mobility device 100, and may return the result of processing. The cloud system 200 performing this function may be configured by including a master cluster 210 and edge clusters 220.

The master cluster 210 may schedule tasks offloaded from the SD-mobility device 200 for the edge clusters 220. The edge clusters 220 may process tasks offloaded by the SD-mobility device 100 and allocated through the master cluster 210, and may return the result of processing.

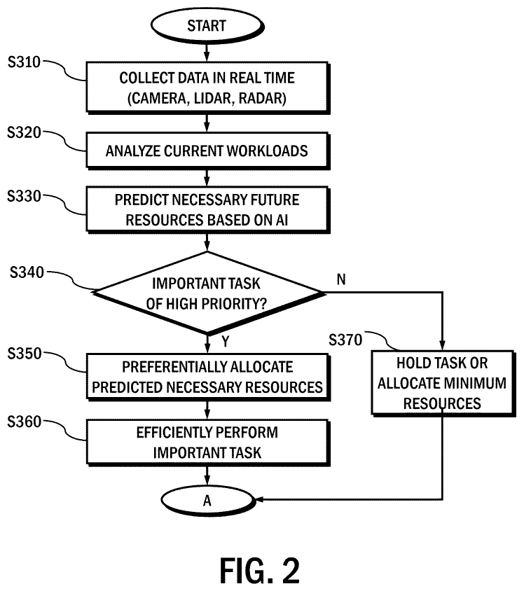

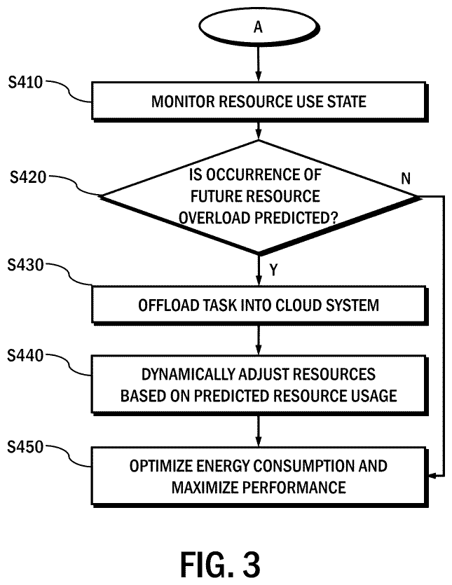

An orchestration process in the SDMI system presented in FIG. 1 will be described in detail hereinbelow with reference to FIGS. 2 and 3. FIG. 2 is a flowchart illustrating an orchestration method in an SDI implementation environment according to another embodiment, and FIG. 3 is a flowchart illustrating the orchestration method in the SDI implementation environment according to another embodiment.

As shown in FIG. 2, the SD-mobility device 100 may collect data in real time in the process of traveling and performing a given mission (S310). The data collected may include data generated in a sensor (a camera, a light detection and ranging (LiDAR), and a radio detection and ranging (RADAR)) of the SD-mobility device 100.

The SD-mobility device 100 may analyze current workloads based on the collected data (S320), and may predict future resource usage needed for each task, based on accumulated analysis results (S330).

Here, tasks may include tasks for traveling and tasks for performing missions. The resources may include a central processing unit (CPU), a memory, a network device. At step S330 of predicting necessary future resource usage, an AI prediction model that is pre-trained to receive accumulated results of analyzing workloads and to predict necessary future resource usage.

The SD-mobility device 100 may preferentially allocate predicted necessary resources to an important task that has a high priority (S340-Y) (S350), and may perform the important task more efficiently (S360). The important task may include tasks that require safety and urgency such as processing/analysis of traveling data of the SD-mobility device 100, and tasks for performing urgent operations.

On the other hand, for a general task that has a low priority (S340-N), the SD-mobility device 100 may hold the task or may allocate minimum resources other than the predicted necessary resources (S370). The general task may include tasks except for the important tasks mentioned above, and may be general tasks that do not require safety and urgency.

Thereafter, as shown in FIG. 3, the SD-mobility device 100 may continuously monitor a network state, a resource use state (S410), and may predict occurrence of future resource overload (S420). At step S420 of predicting occurrence of future resource overload, an AI prediction model that is pre-trained to receive the result of monitoring at step S410 and to predict future resource overload may be utilized.

When the occurrence of future resource overload is predicted at step S420 (S420-Y), the SD-mobility device 100 may offload some of the tasks into the cloud system 200 (S430), thereby preventing performance degradation caused by resource overload.

Meanwhile, the cloud system 200 receiving the offloaded tasks may dynamically adjust its own resources based on the necessary future resource usage predicted at step S330 of FIG. 2, thereby securing resources for performing the offloaded tasks (S440).

Through this process, the SD-mobility device 100 may optimize energy consumption of the tasks to which resources are allocated and may maximize system performance and extend a battery lifespan (S450). When the occurrence of future resource overload is not predicted at step S420 (S420-N), steps S430 and S440 may not be performed.

Hereinafter, the step of offloading tasks (S430) in FIG. 3 will be described in detail. Specifically, a criterion for the SD-mobility device 100 to select tasks to offload into the cloud system 200 will be described.

Tasks that are related to traveling among the tasks performed by the SD-mobility device 100 require safety and urgency, and hence, they are not offloaded in principle. Tasks for performing missions may be divided into urgent tasks and non-urgent general tasks, and the general tasks are subject to offloading.

However, in a special circumstance, even traveling-related tasks and urgent tasks for performing missions may be subject to offloading. In this case, the complexity or difficulty of tasks are high so that it is better for the cloud system 200, which has a higher level of resources, to perform the tasks than the SD-mobility device 100 which has a lower level of resources.

Specifically, 1) a task that is predicted to be less than or equal to a reference value of performance accuracy when it is performed by the SD-mobility device 100, 2) a task that has a slightly low similarity between currently collected data and previously collected data, that is, a task that is predicted to be difficult to perform accurately due to different data from previous data, 3) a task that is determined to be unsuccessful may be performed by the cloud system 200. A task may be determined to be unsuccessful when accuracy outputted with the result of performing the task is less than a reference value or when feedback on the result of performing the task from a user or an ambient environment is negative.

Furthermore, 1) when the current time zone is a time zone where many complex and difficult tasks occur, 2) when the current weather condition is not favorable, 3) when the current illuminance is low, it may be difficult to perform the tasks, so that the tasks may be allowed to be offloaded into the cloud system 200 which has a high level of resources.

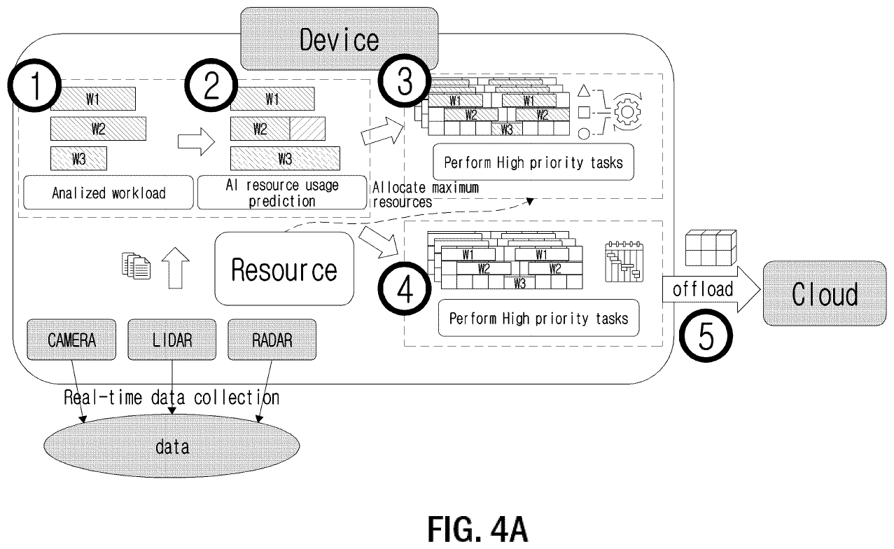

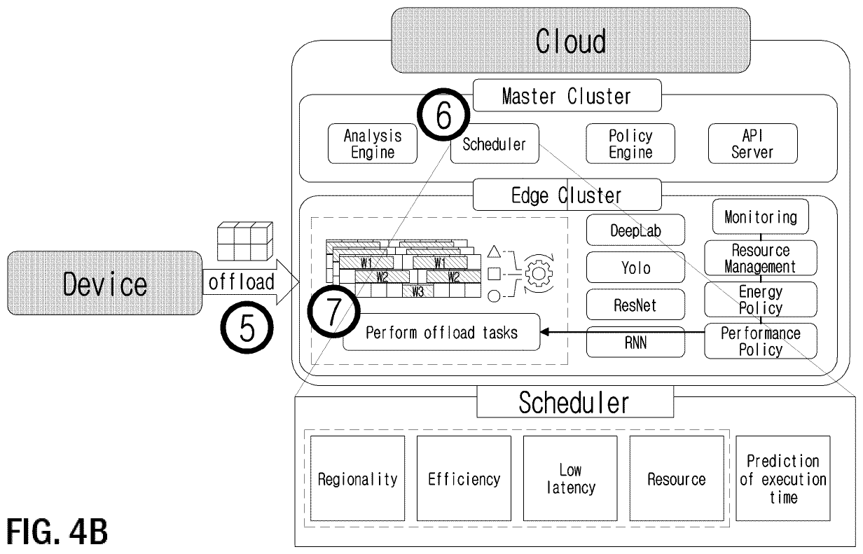

Hereinafter, the method of FIGS. 2 and 3 will be additionally described with reference to FIGS. 4A and 4B. FIGS. 4A and 4B illustrate operations of the SD-mobility device 100 and the cloud system 200 for orchestration in an SDI implementation environment.

As shown in FIG. 4A, the SD-mobility device 100 may collect sensor data in real time and analyze workloads (\textcircled{1}), may predict necessary future resource usage based on AI (\textcircled{2}), and then, may preferentially allocate the predicted necessary resources to an important task having a high priority and process the task (\textcircled{3}).

The SD-mobility device 100 may predict the occurrence of resource overload based on AI by continuously monitoring a resource use state based on AI (\textcircled{4}), and may offload tasks into the cloud system 200 when necessary (\textcircled{5}).

As shown in FIG. 4B, the master cluster 210 of the cloud system 200 may manage a policy and may schedule the offloaded tasks for an optimal edge cluster 220 (\textcircled{6}). Scheduling may be performed by weighted-summing mixed importance and a precited execution time. That is, the offloaded tasks may be scheduled for an edge cluster 220 that has high mixed importance and a predicted short execution time. The mixed importance may be calculated by weighted-summing regionality (proximity), efficiency, latency time, resource availability. The offloaded tasks may be scheduled for an edge cluster 220 that is a close region, has high task efficiency, has a short latency time, and has high resource availability.

The edge cluster 220 may perform the tasks that are offloaded and allocated by the master cluster 210 (\textcircled{7}). The edge cluster 220 may perform complicated task processing using a deep learning model such as DeepLab, Yolo, ResNet, or the like. All processes may be adjusted in real time, and overall energy efficiency of the system may be improved and resource use may be optimized. By doing so, the system may reduce resource waste and maintain optimal performance suited to characteristics of each device.

Up to now, the resource usage prediction model-based orchestration method in the SDI implementation environment has been described with reference to preferred embodiments.

In the above-described embodiments, resources may be dynamically allocated to tasks according to importance, based on prediction of future resource usage through real-time monitoring of resource usage of an SD-mobility device such as an SDV, an SRD, an SDA in the SDI implementation environment, so that limited resources may be efficiently used. Furthermore, the SD-mobility device may be supported to maintain optimal performance by predicting the occurrence of resource overload in the SDI implementation environment and offloading tasks in association with the cloud system.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An orchestration method comprising:
collecting, by a software-defined (SD)-mobility device, data in real time;
analyzing, by the SD-mobility device, current workloads based on the collected data;
predicting, by the SD-mobility device, necessary future resource usage for each task based on accumulated analysis results; and
preferentially allocating, by the SD-mobility device, predicted necessary resources to an important task.

2. The orchestration method of claim 1, further comprising holding, by the SD-mobile device, a general task or allocating minimum resources to the general task.

3. The orchestration method of claim 2, wherein the important task comprises a task related to traveling of the SD-mobility device, and a task that needs to be performed urgently among tasks for performing missions, and
wherein the general task is a task except for the important task among the tasks of the SD-mobility device.

4. The orchestration method of claim 3, wherein collecting comprises collecting sensor data in the process of traveling and performing a given mission, and
wherein the sensor comprises at least one of a camera, a LiDAR, and a RADAR.

5. The orchestration method of claim 2, further comprising:
predicting, by the SD-mobility device, the occurrence of future resource overload by monitoring a resource use state; and
when the occurrence of future resource overload is predicted, offloading, by the SD-mobility device, some of the tasks into a cloud system.

6. The orchestration method of claim 5, further comprising performing, by the cloud system, the offloaded task by dynamically adjusting its own resources based on the predicted necessary future resource usage.

7. The orchestration method of claim 6, wherein offloading comprises offloading a traveling-related task among the tasks performed by the SD-mobility device, and an urgent task among the tasks for performing missions only in a special circumstance.

8. The orchestration method of claim 6, further comprising scheduling, by a master cluster of the cloud system, the offloaded task for an optimal edge cluster,
wherein scheduling is performed by weighted-summing a mixed importance and a predicted execution time,
wherein the mixed importance is calculated by weighted-summing regionality, efficiency, latency time, resource availability.

9. The orchestration method of claim 1, wherein the SD-mobility device is any one of a software-defined vehicle (SDV), a software-defined robot (SDR), and a software-defined airspace (SDA) which perform a given mission while traveling based on SD technologies.

10. A software-defined mobility infrastructure (SDMI) system comprising:
an SD-mobility device configured to collect data in real time, to analyze current workloads, to predict necessary future resource usage for each task based on accumulated analysis results, and preferentially allocate predicted necessary resources to an important task; and
a cloud system connected with the SD-mobility device via a network.

11. An orchestration method comprising:
predicting, by a SD-mobility device, the occurrence of future resource overload by monitoring a resource use state; and
when the occurrence of future resource overload is predicted, offloading, by the SD-mobility device, some of the tasks into a cloud system.
